(19) United States
(12) Patent Application Publication
(10) Pub. No.: US 2023/0039501 A1
(43) Pub. Date: Feb. 9, 2023

(54) Mouth protection device for a respiratory protection system

(71) Applicant: Optrel Holding AG, Wattwil (CH)

(72) Inventors: Jonathan HEUSSER, Uerikon (CH); Robert BUECHEL, Wattwil (CH); Daniel BLOECHLINGER, St. Gallenkappel (CH); Jasper BROUWER, Switzerland (CH)

(21) Appl. No.: 17/787,494

(22) PCT Filed: Dec. 18, 2019
(86) PCT No.: PCT/EP2020/087025

§ 371 Date: Jun. 20, 2022

(30) Foreign Application Priority Data
Dec. 20, 2019 (EP) 19218878.7

(51) Int. Cl. A62B 18/02; A41D 13/11; A62B 18/08; A62B 23/02

(52) U.S. Cl. CPC A62B 18/025; A41D 13/1161; A62B 18/084; A62B 23/025

(57) ABSTRACT

A mouth protection device for a respiratory protection system, in particular a blower respiratory protection system, comprises at least one mask base body which is configured to cover a mouth and/or nose region of a user and which delimits a breathing zone at least partially, and comprises at least one breathing air supply line, which is connected to the mask base body and delimits at least one breathing air channel that ends in the breathing zone and is configured for guiding an active breathing air flow,

wherein the mask base body is made at least largely of a flexurally soft material, the mask base body being made at least largely of a textile material.

### PRIOR ART

The invention concerns a mouth protection device for a respiratory protection system.

A mouth protection device for a respiratory protection system, in particular a blower respiratory protection system, has already been proposed, with at least one mask base body which is configured to cover a user's mouth and/or nose region and which delimits a breathing zone at least partially, and with at least one breathing air supply line, which is connected to the mask base body and delimits at least one breathing air channel that ends in the breathing zone and is configured for guiding an active breathing air flow.

The objective of the invention is in particular to provide a generic device having improved characteristics regarding compactness and comfort. The objective is achieved according to the invention by the features of patent claim 1 while advantageous implementations and further developments of the invention may be gathered from the subclaims.

### ADVANTAGES OF THE INVENTION

The invention is based on a mouth protection device for a respiratory protection system, in particular a blower respiratory protection system, with at least one mask base body which is configured to cover a user's mouth and/or nose region and which delimits a breathing zone at least partially, and with at least one breathing air supply line, which is connected to the mask base body and delimits at least one breathing air channel that ends in the breathing zone and is configured for guiding an active breathing air flow.

It is proposed that the mask base body is made at least largely of a flexurally soft material, the mask base body being made at least largely of a textile material. Preferably the mask base body is completely made of a flexurally soft material. It would however be conceivable that reinforcing elements are provided on and/or in the mask base body, which hold the mask base body at least partially in a defined basic shape. Preferably the mask base body is made of a textile.

A “respiratory protection system” is in particular to mean, in this context, a system with a blower device and with a mouth protection device, which is configured to actively provide an airflow for a breathing air supply of a user. The respiratory protection system is in particular configured, during operation, to create by means of a blower device an airflow which is fed to the mouth protection device of the respiratory protection system. Preferably the blower device is connected to the mouth protection device of the respiratory protection system via at least one breathing air supply line. Preferably the respiratory protection system is configured, in operation, by means of the blower device, to suck air from an environment, to purify the air, in particular to filter the air, and to actively feed the purified air to a user via the mouth protection device. By a “mouth protection device” is in particular, in this context, a device to be understood which forms a mouth protection and is configured to be worn at least in a user's mouth and/or nose region. Preferably the device is configured to form a breathing zone in front of the user's mouth and/or nose region, which is continuously supplied with breathing air during operation. Preferentially the mouth protection device is configured to directly supply a user with breathing air and to protect a user's mouth and/or nose region from external influences, in particular from gases, particles and/or suspended matter. Preferentially the mouth protection device is free of a cover of a user's eyes, in particular of a user's eye region.

Furthermore, a “mask base body” is in particular to mean, in this context, a base body of the mouth protection device that is configured for directly covering a user's mouth and/or nose region. The mask base body is in particular formed by a planar component, which is configured to extend over a user's mouth and/or nose region. Preferably the mask base body delimits a breathing zone, which is in an operation state formed by the mask base body and the face of the user. The breathing air supply line is in particular realized by a tube that is configured to delimit a breathing air channel. The breathing air supply line in particular connects a blower device of the respiratory protection system to the mask base body of the mouth protection device of the respiratory protection system. The breathing air channel is in particular configured for guiding a breathing air flow into the breathing zone, where the breathing air flow is configured, in operation, for supplying the user with air.

Preferably, a “flexurally soft component” is in particular to mean, in this context, a component, a planar component, which has flexurally soft characteristics at least in a direction that is perpendicular to a main extent direction. Preferably it is in particular to mean a dimensionally instable component. Particularly preferentially it is in particular to mean a component which in an extended state produces a counterforce against a pressure force that acts parallel to a main extent direction, said counterforce being smaller than a weight force of the component. Preferably the counterforce amounts to maximally 70%, preferably to maximally 50% and particularly preferentially to maximally 30% of a weight force. Different flexurally soft components are conceivable which are deemed expedient by someone skilled in the art, in particular, however, the flexurally soft component is realized at least partly or completely by a chain, a strap or a rope. Preferably, it is in particular to mean a component that differs from a rod or something like that. By a “planar component” is here in particular a component to be understood which in a laid-out state has a height extent that is manyfold smaller than a length extent and a transverse extent of the component. Preferably a height extent is less than 5 cm, preferentially less than 2 cm and particularly preferentially less than 1 cm. “Manyfold smaller” is here in particular to mean at least five times as small, preferably at least 10 times as small and particularly preferentially at least 20 times as small.

By a “textile material” is in particular, in this context, a material to be understood that is implemented of a textile raw material, like for example natural fibers and/or synthetic fibers, which is made into linear, planar and spatial shapes by a variety of methods. In particular, the textile material may additionally also comprise non-textile raw materials, which are made into linear, planar and spatial shapes together with the textile materials by a variety of methods. The mask base body is in particular at least largely made of a planar textile shape, like in particular a fabric, interlaced yarns, a knitted fabric, a netting, a meshed knitted fabric, a nonwoven material and/or a felt. “Configured” is in particular to mean specifically programmed, designed and/or equipped. By an object being configured for a certain function is in particular to be understood that the object fulfills and/or carries out said certain function in at least one application state and/or operation state. The term “at least largely” is here in particular to mean at least by 55%, advantageously at least by 65%, preferably at least by 75%, particularly preferentially at least by 85% and especially advantageously at least by 95%.

The implementation of the mouth protection device according to the invention in particular allows providing an advantageously flexible mouth protection device. It is in particular possible to provide a mouth protection device which adapts to a face shape. It is in particular possible to provide a mouth protection device for different shapes and sizes of faces. In particular, an advantageously high level of wearing comfort can be provided. This in particular allows obtaining an advantageously high comfort of the mouth protection device. Furthermore, an advantageously compact mouth protection device can be provided. In particular, it is thus also possible to provide an advantageously comfortable mouth protection device. It is in particular possible to provide a mouth protection device that is advantageously comfortable when worn. Furthermore, an advantageously lightweight mouth protection device can be provided.

It is further proposed that the mouth protection device comprises at least one further breathing air supply line, which is redundant to the breathing air supply line, which is connected with the mask base body and which delimits at least one further breathing air channel that ends in the breathing zone and is configured for guiding an active breathing air flow. Preferably the further breathing air supply line has a function that is redundant to the breathing air supply line. The further breathing air supply line in particular serves to increase a safety of a supply with the breathing air flow. Preferentially the breathing air supply line and the further breathing air supply line are in each case functional independently from each other. This in particular allows ensuring supply with the breathing air flow also in the case of a clogged and/or squeezed-off breathing air supply line or further breathing air supply line. The breathing air supply line and the further breathing air supply line are in particular guided on a user in different ways so as to avoid simultaneous squeezing of the breathing air supply lines.

Moreover, it is proposed that the at least one further breathing air supply line is arranged on a side of the mask base body that faces away from the breathing air supply line. Preferably the breathing air supply lines are configured to be guided along on different sides of the user's head. Preferably the breathing air supply lines are in each case connected to the mask base body at opposite ends of the mask base body, respectively. The breathing air supply lines are in particular configured to be guided on opposite sides of the user's neck. Preferably the mask base body has an at least approximately elliptic shape, the breathing air supply lines being respectively connected to the mask base body in one of the two outer principal vertices of the ellipse. In this way it is in particular possible to ensure a supply with the breathing air flow also in the case of a clogged or squeezed-off breathing air supply line or further breathing air supply line. The breathing air supply line and the further breathing air supply line are in particular guided on a user in different ways so as to avoid simultaneous squeezing of the breathing air supply lines. It is in particular possible to provide an advantageously redundant breathing air supply.

It is further proposed that the mouth protection device comprises at least one fastening strap for fixing the mask base body on a user's head, and at least one connection unit for a simultaneous plug-in connection of the fastening strap and the at least one breathing air supply line to the mask base body. Preferably the fastening strap is in particular implemented by an elastic strap, like in particular a rubber strap. Preferentially the fastening strap in particular has a width at least approximately corresponding to a width of the breathing air supply line. Preferably an effective length of the fastening strap is realized so as to be adjustable. The fastening strap in particular extends from a first end of the mask base body to an opposite-situated second end of the mask base body. The fastening strap in particular extends from a first end of the mask base body, in which the breathing air supply line is connected with the mask base body, to an opposite-situated second end of the mask base body, in which the further breathing air supply line is connected with the mask base body. By a “connection unit” is in particular, in this context, a unit to be understood which forms an interface for an—in particular toollessly—releasable coupling of the fastening strap and the at least one breathing air supply line with the mask base body. The connection unit in particular enables a multiple coupling and uncoupling, executed by an operator, of the fastening strap and the at least one breathing air supply line with the mask base body. The connection unit in particular serves for a pulling off or taking off the mouth protection device. A coupling may herein be brought about, for example, by a plugging movement, by a rotary movement and/or by a combination of a plugging and a rotary movement. Preferably the connection unit comprises at least one first coupling element and at least one second coupling element that corresponds to the first coupling element. Preferentially a first coupling element forms an interface receptacle while the second coupling element forms an interface projection. The first coupling element is in particular fixedly connected with the mask base body. The second coupling element is in particular fixedly connected with the fastening strap and the at least one breathing air supply line. In particular, the first coupling element is embodied by a tube connection. Preferably the mouth protection device comprises two connection units, in particular a first connection unit for the breathing air supply line and a second connection unit for the further breathing air supply line. In this way in particular an advantageously simple releasing of the mouth protection device is achievable. It is in particular achievable that both the fastening strap and the breathing air supply line can be released via only one connection unit. Preferably this in particular allows ensuring that the mouth protection device can only be worn with a connected breathing air supply line as the mouth protection device cannot be worn without the fastening strap and the fastening strap cannot be coupled with the mask base body without the breathing air supply line.

It is also proposed that the mouth protection device comprises at least one adjusting unit, wherein at least an effective length of a side edge of the mask base body is implemented so as to be at least partially adjustable by means of the adjusting unit. Preferably, an effective length of a side edge from a first end to a second end of the mask base body is implemented so as to be at least partially adjustable. Preferentially the side edge extends at least substantially parallel to a main extent direction of the mask base body. Preferably the adjusting unit in particular comprises a cord, in particular an elastic cord, and a cord clamp. The cord of the adjusting unit in particular runs in a channel of the mask base body from the first end of the mask base body to the second end of the mask base body, which is situated opposite the first end. The cord is in particular fastened at the first end and at the second end. In particular, an effective length of the cord, and thus of the side edge of the mask base body, is implemented so as to be manually adjustable by means of the cord clamp. In particular, an effective length of the cord is implemented so as to be manually adjustable by the formation of differently sized loops of the cord by means of the cord clamp. By a “main extent direction” of an object is herein in particular a direction to be understood which runs parallel to a longest edge of a smallest geometric rectangular cuboid just still completely enclosing the object. This in particular allows achieving an advantageously simple and comfortable adjustability of the mouth protection device, in particular of the mask base body. In particular, this allows adapting the mouth protection device to different sizes of faces.

Beyond this it is proposed that the mouth protection device comprises at least one separating layer, which is connected to the mask base body and is configured to at least partially separate the breathing zone from an outlet region, the outlet region being at least partially delimited by the mask base body. Preferably the outlet region is arranged at least below the breathing zone. In an operation state, the mask base body in particular delimits, together with the user's face, a spatial region which is divided into a breathing zone and an outlet region by the separating layer. The separating layer is in particular realized integrally with the mask base body. Preferably the separating layer has in a middle region a recess connecting the breathing zone to the outlet region. “Integrally” is in particular to mean at least connected by substance-to-substance bond, for example by a welding process, a gluing process, an injection-molding process and/or a different process that is deemed expedient by someone skilled in the art, and/or advantageously formed in one piece, like for example by a production from a cast and/or by a production in a one-component or multi-component injection-molding procedure and advantageously made of a single blank, or firmly sewed. This in particular enables an advantageous air guidance. Furthermore, in particular an at least partial separation of breathing air and breathed-out air is achievable.

It is further proposed that the separating layer is at least substantially made of a textile material. This in particular allows providing an advantageously flexible mouth protection device. In particular, a mouth protection device can be provided for different shapes and sizes of faces. In particular, an advantageously high level of wearing comfort can be provided. It is furthermore possible to provide an advantageously lightweight mouth protection device.

Furthermore it is proposed that the separating layer is configured for a defined air guidance, wherein the separating layer is configured to guide the breathing air flow past a user's mouth and/or nose region before the breathing air flow reaches the outlet region. For this purpose, the separating layer preferably has in its middle region a recess connecting the breathing zone to the outlet region. Preferably the breathing air flow flows during operation from the breathing air channel into the breathing zone and from the breathing zone through the recess into the outlet region. The recess is preferably arranged in a proximity of a user's mouth and/or nose region. In this way in particular an advantageous air guidance is achievable. Furthermore, in particular an at least partial separation of breathing air and breathed-out air is achievable.

it is also proposed that the mouth protection device comprises at least one discharge valve, which is configured to regulate a pressure in the breathing zone to an at least approximately constant value. Preferably, the discharge valve is in particular implemented by an overpressure valve, in particular a one-way overpressure valve, which is configured to open in excess of a defined overpressure in the breathing zone and/or in the outlet region, relative to an environment. Preferably the discharge valve is in particular implemented by a mechanical valve. In particular, the mask base body is not completely sealed with respect to the user's face, such that air may also leave at a transition from the mask base body to the face, besides the discharge valve. If there is too much leakage or if the mouth protection device is taken off, it is in particular conceivable that at the transition from the mask base body to the face the pressure in the breathing zone drops below the limit value of the discharge valve and the pressure drops. Under regular conditions, the pressure in the breathing zone is regulated to an at least approximately constant value by means of the discharge valve. This in particular allows providing an advantageously reliable mouth protection system. In particular, a constant pressure can be provided. Furthermore, it is in particular possible to monitor a tightness of the system on the basis of the pressure.

Beyond this it is proposed that the mask base body comprises at least one subregion which is implemented so as to be air-permeable. The subregion is in particular made of an air-permeable textile. Preferentially the subregion adjoins the outlet region. The subregion in particular serves for a defined discharge of air in the outlet region. During operation, there is an overpressure in the outlet region with respect to an environment, such that air is discharged only from the outlet region to the environment. The subregion is in particular provided in addition to the discharge valve; it would however also be conceivable that only the subregion is provided. It would in particular be conceivable that a pass-through quantity could be controlled via a tightness of the subregion. This in particular allows providing an advantageously reliable mouth protection system. In particular, a defined exit point can be created. It is in particular possible to avoid inadvertent air leakage.

The invention is furthermore based on a respiratory protection system, in particular a blower respiratory protection system, with the mouth protection device and with at least one blower device for a generation of a breathing air flow. It is proposed that the at least one blower device is configured to create an overpressure in the mouth protection device. Preferably the at least one blower device is configured to create in the mouth protection device a relative overpressure with respect to an environment. By a “blower device” is in particular, in this context, a device to be understood which is configured for an active generation of an airflow for supplying a user with breathing air. The blower device is in particular configured, in operation, to feed the airflow to the mouth protection device of the respiratory protection system. Preferably the blower device is connected to the mouth protection device of the respiratory protection system via at least one breathing air supply line. Preferably the blower device is configured, in operation, to suck air from an environment, to purify the air, in particular to filter the air, and to actively feed the purified air to a user, in particular via the mouth protection device. Preferentially the blower device is configured to generate an active airflow. The blower device is in particular configured to generate an overpressure airflow. The fan is in particular configured, during operation, for an active generation of an airflow. In particular, the fan is configured for an active suction of air from an environment and for an active transport of the air to the mouth protection device of the respiratory protection system. The fan is in particular implemented by an axial fan. This in particular allows providing an advantageously comfortable respiratory protection system. In particular, a reliable breathing air supply is enabled.

It is also proposed that the at least one blower device is configured to create a volume flow of the breathing air flow of at least 50 l/min and maximally 250 l/min. Preferably the blower device comprises a fan for generating an airflow. The fan is in particular configured to actively generate an airflow during operation. The fan is in particular configured for an active suction of air from an environment and for an active transport of the air to the mouth protection device of the respiratory protection system. The fan is in particular implemented by an axial fan. Preferably the fan is configured to create a volume flow of the airflow of at least 80 l/min and maximally 120 l/min. This in particular allows providing an advantageously compact high-performance blower device.

Moreover it is proposed that the respiratory protection system comprises at least one breathing air line, which is connected with the blower device, which is configured to guide the breathing air flow and is configured to divide the breathing air flow to the breathing air supply line and the further breathing air supply line. Preferably the breathing air line is directly connected to a breathing air outlet of the blower device. Preferentially the breathing air line is coupled with the breathing air supply line and the further breathing air supply line via a T-connection piece. In this way in particular an advantageous dividing of the breathing air flow is enabled.

The mouth protection device according to the invention and/or the respiratory protection system according to the invention shall herein not be limited to the application and implementation described above. In particular, in order to fulfill a functionality that is described here, the mouth protection device according to the invention and/or the respiratory protection system according to the invention may comprise a number of individual elements, components and units that differs from a number given here. Furthermore, in regard to the value ranges given in the present disclosure, values situated within the limits mentioned shall also be considered as disclosed and as applicable according to requirements.

### DRAWINGS

Further advantages will become apparent from the following description of the drawings. In the drawings two exemplary embodiments of the invention are illustrated. The drawings, the description and the claims contain a plurality of features in combination. Someone skilled in the art will purposefully also consider the features separately and will find further expedient combinations.

It is shown in:

FIG. 1 a respiratory protection system with a blower device, with a mouth protection device, with a vest and with an external operating unit, and a user, in a schematic illustration,

FIG. 2 the blower device of the respiratory protection system in a schematic illustration,

FIG. 3 the blower device of the respiratory protection system, with a fan and with a filter element, in a schematic sectional view along the section line II-II,

FIG. 4 the mouth protection device of the respiratory protection system and the user's head, in a schematic illustration,

FIG. 5 the mouth protection device of the respiratory protection system, in a schematic partial sectional view,

FIG. 6 a portion of the mouth protection device of the respiratory protection system, in a schematic sectional view, and

FIG. 7 an alternative blower device of a respiratory protection system, with a fan, with a filter element and with a further filter element, in a schematic sectional view.

### DESCRIPTION OF THE EXEMPLARY EMBODIMENTS

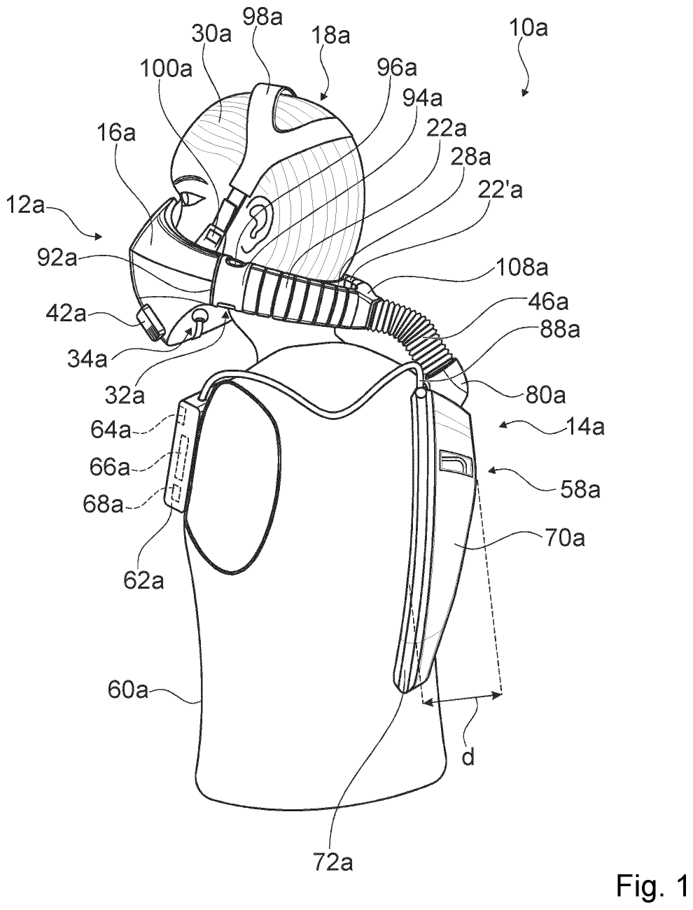

FIG. 1 shows a respiratory protection system 10a. The respiratory protection system 10a is realized by a blower respiratory protection system. The respiratory protection system 10a is in particular realized by a blower respiratory protection system of safety class TH3.

The respiratory protection system 10a is configured for a protection of a user 18a from particles like smoke, aerosols and/or dust. Furthermore, the respiratory protection system 10a is in addition capable of protecting from unpleasant smells and noxious ozone. It is in particular conceivable that in environments with insalubrious or even toxic gases, the respiratory protection system 10a protects the user 18a from organic, inorganic and/or acidic gases. The respiratory protection system 10a comprises a blower device 14a and a mouth protection device 12a. The blower device 14a is configured to generate a breathing air flow 26a. The blower device 14a is configured to generate a breathing air flow 26a for the mouth protection device 12a.

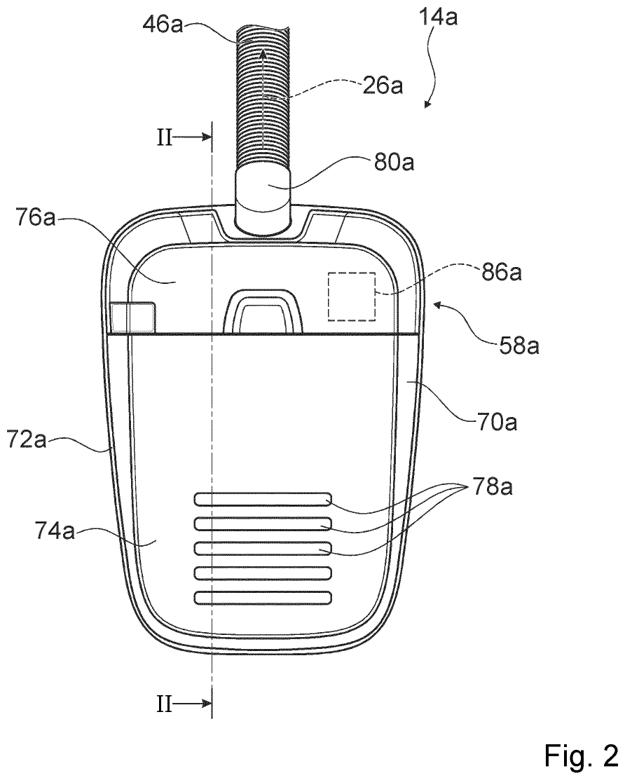

The blower device 14a comprises a housing unit 58a. The housing unit 58a is realized by a plastic housing. The housing unit 58a comprises two housing shells 70a, 72a, namely a first housing shell 70a and a second housing shell 72a, which are connected to each other. The first housing shell 70a comprises two openable covers 74a, 76a, via which an inner space of the housing unit 58a can be made accessible. The second housing shell 72a forms a rear side of the housing unit 58a, which faces toward the user 18a in a state when it is worn. The second housing shell 72a is concavely curved on an outer side. The curvature of the second housing shell 72a is adapted to a back curvature of a human. The housing unit 58a further comprises several air inlet openings 78a. The air inlet openings 78a are implemented by slits in the first housing shell 70a. In operation, the air inlet openings 78a serve for suctioning an ambient air via an airflow 50a. Furthermore, the housing unit 58a comprises an air outlet opening 80a. The air outlet opening 80a is realized by a tube connection piece at the first housing shell 70a. In operation, the air outlet opening 80a serves for an output of the purified airflow 50a, in particular a breathing air flow 26a. In operation, the breathing air flow 26a is forwarded from the air outlet opening 80a to the mouth protection device 12a (FIGS. 1, 2).

The housing unit 58a has a thickness d of less than 70 mm. The housing unit 58a has a thickness d of less than 50 mm.

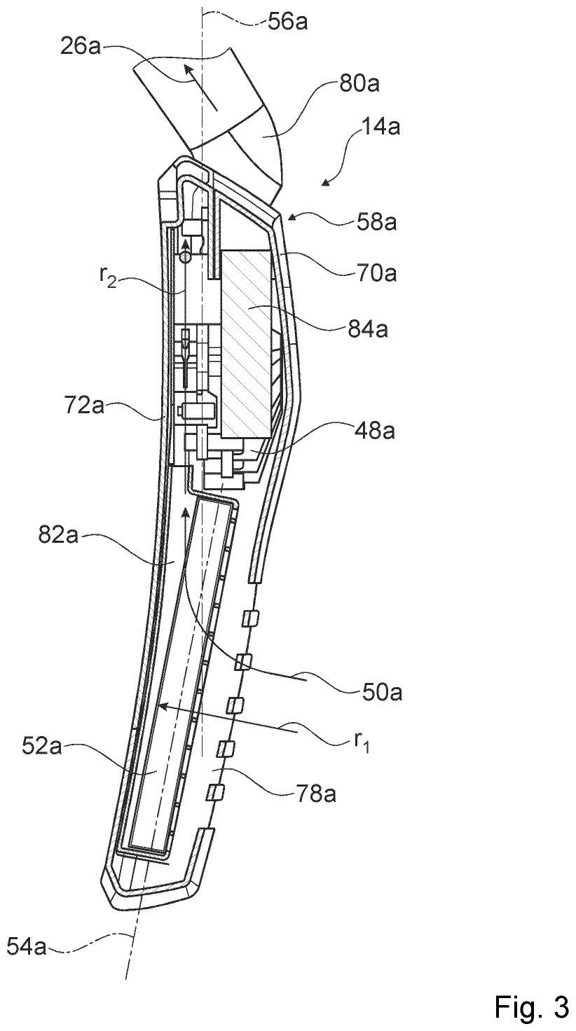

The blower device 14a further comprises a fan 48a for a generation of an airflow 50a. The blower device 14a is configured to create an overpressure in the mouth protection device 12a. The fan 48a is configured to create an overpressure in the mouth protection device 12a. The fan 48a is configured to create a volume flow of the airflow 50a of at least 50 l/min and maximally 250 l/min. The fan 48a is configured to create a volume flow of the airflow 50a of at least 80 l/min and maximally 120 l/min. During operation, the blower device 14a is configured to create in the mouth protection device 12a, by means of the fan 48a, a relative overpressure with respect to an environment. The fan 48a is embodied by an electrical radial fan. However, principally a different implementation, deemed expedient by someone skilled in the art, would also be conceivable. The fan 48a is arranged in the housing unit 58a. A main extent plane 56a of the fan 48a extends at least substantially parallel to a main extent plane of the housing unit 58a. The fan 48a is arranged in an upper region of the blower device 14a. The air outlet opening 80a is arranged on an exit side of the fan 48a. The blower device 14a further comprises a control and/or regulation unit 86a for a control and/or regulation of the fan 48a during operation. The control and/or regulation unit 86a is in particular configured to automatically adapt a performance grade of the fan 48a. The control and/or regulation unit 86a is configured to adjust an air flow level of the fan 48a depending on a saturation of a filter element 52a. Furthermore, the control and/or regulation unit 86a is configured for an automatic airflow control and airflow adaption (FIG. 3).

The blower device 14a also comprises the filter element 52a. The filter element 52a is configured to be flown through by the airflow 50a. The filter element 52a is implemented by a rectangular-cuboid-shaped filter module. The filter element 52a is implemented by an aerosol filter. The filter element 52a is embodied as a depth filter, in particular as a lamellate filter. It would however also be conceivable that the filter element 52a is implemented as a gas filter, in particular as an A1B1E1 gas filter. The filter element 52a is arranged in the housing unit 58a. A main extent plane 54a of the filter element 52a extends at least substantially parallel to a main extent plane of the housing unit 58a. The filter element 52a is arranged in a lower region of the blower device 14a. The housing unit 58a accommodates the fan 48a and the filter element 52a. On an entry side of the filter element 52a, the air inlet opening 78a is arranged. Furthermore, the filter element 52a is implemented so as to be exchangeable via the cover 74a (FIG. 3).

The fan 48a is arranged next to the filter element 52a, the airflow 50a being deflected between the fan 48a and the filter element 52a. The filter element 52a and the fan 48a are together arranged in the housing unit 58a. The housing unit 58a further comprises an air conveying channel 82a, which accommodates the filter element 52a and which is configured to guide the airflow 50a between the filter element 52a and the fan 48a. The filter element 52a is arranged along the airflow 50a fluidically upstream of the fan 48a. The airflow 50a between the fan 48a and the filter element 52a is deflected by at least approximately 90°. A deflection of the airflow 50a is brought about in the air conveying channel 82a. However, it would also be conceivable that an air conveying channel 82a can be dispensed with. A flow-through direction r₁ of the airflow 50a through the filter element 52a is substantially different from a flow-through direction r₂ of the airflow 50a through the fan 48a. The flow-through direction r₂ of the airflow 50a through the fan 48a runs parallel to the main extent plane 56a of the fan 48a. In an implementation of the fan 48a as an axial fan it would, however, also be conceivable that the flow-through direction r₂ of the airflow 50a through the fan 48a runs perpendicularly to the main extent plane 56a of the fan 48a. The flow-through direction r₁ of the airflow 50a through the filter element 52a runs perpendicularly to the main extent plane 54a of the filter element 52a. The flow-through direction r₁ of the filter element 52a is angled by at least approximately 90° with respect to the flow-through direction r₂ of the fan 48a (FIG. 3).

The filter element 52a has the main extent plane 54a. The fan 48a has the main extent plane 56a. It would be conceivable that the main extent plane 54a extends parallel to the main extent plane 56a, wherein a distance between the main extent plane 54a of the filter element 52a and the main extent plane 56a of the fan 48a is smaller than a maximum thickness of the filter element 52a. Preferentially, in the case of a parallel implementation, a distance between the main extent plane 54a of the filter element 52a and the main extent plane 56a of the fan 48a would be smaller than 50 mm, preferably smaller than 30 mm and particularly preferentially smaller than 10 mm. In the illustrated implementation the main extent plane 54a of the filter element 52a is angled with respect to the main extent plane 56a of the fan 48a. An angle included by the main extent plane 54a of the filter element 52a and the main extent plane 56a of the fan 48a amounts to more than 80°, preferably more than 120° and particularly preferentially more than 160°. The angle included by the main extent plane 54a of the filter element 52a and the main extent plane 56a of the fan 48a amounts to at least approximately 165°. A normal vector of the main extent plane 54a of the filter element 52a that intersects with the filter element 52a and a normal vector of the main extent plane 56a of the fan 48a that intersects with the fan 48a include a smallest angle of at least approximately 15°. Preferably the main extent plane 56a of the fan 48a and the main extent plane 54a of the filter element 52a include a smallest angle of at least 60°, preferably at least 70°, with an imaginary plane in which the section line between the main extent plane 56a of the fan 48a and the main extent plane 54a of the filter element 52a runs and which is situated symmetrically between the filter element 52a and the fan 48a. Preferentially a section line of the main extent plane 54a of the filter element 52a and the main extent plane 56a of the fan 48a runs in a proximity of the filter element 52a and of the fan 48a. A smallest distance between the section line and the filter element 52a is in particular smaller than 15 cm, preferably smaller than 10 cm and particularly preferentially smaller than 5 cm. A smallest distance between the section line and the filter element 52a is smaller than a smallest distance between the fan 48a and the filter element 52a. At least a large portion of normal vectors of the main extent plane 54a of the filter element 52a that intersect with the filter element 52a are free of an intersection point with the fan 48a. All normal vectors of the main extent plane 54a of the filter element 52a that intersect with the filter element 52a are free of an intersection point with the fan 48a. The filter element 52a and the fan 48a are partially arranged at an angle next to each other (FIG. 3).

The blower device 14a further comprises an energy storage 84a. The energy storage 84a is embodied by an accumulator. The energy storage 84a serves for an energy supply of the fan 48a. A main extent plane of the energy storage 84a extends at least substantially parallel to a main extent plane of the housing unit 58a. The energy storage 84a is arranged in a lower region of the blower device 14a. The housing unit 58a accommodates the fan 48a, the filter element 52a and the energy storage 84a. The housing unit 58a serves for a protection and an orientation of the fan 48a, the filter element 52a and the energy storage 84a. Furthermore, the energy storage 84a is implemented such that it is exchangeable via the cover 76a (FIG. 3).

The respiratory protection system 10a further comprises an external operating unit 62a. The external operating unit 62a is embodied by a remote control. The operating unit 62a comprises operating elements 64a and a control and/or regulation unit 66a that is configured for a control and/or regulation of the blower device 14a. By way of example, the external operating unit 62a is connected to the blower device 14a via a cable 88a. The control and/or regulation unit 66a of the external operating unit 62a is in particular configured to actuate the control and/or regulation unit 86a of the blower device 14a depending on an input at the operating elements 64a. For example, a performance grade of the fan 48a can be adjusted via the operating elements 64a. Furthermore, the fan 48a can be activated or deactivated via the operating elements 64a. The external operating unit 62a further comprises a sensor unit 68a for capturing environmental parameters. The control and/or regulation unit 66a is configured, in at least one operation state, to control and/or regulate the blower device 14a on the basis of the environmental parameters. The control and/or regulation unit 66a is configured, in operation, to actuate the control and/or regulation unit 86a of the blower device 14a, a performance grade of the fan 48a being adapted via the control and/or regulation unit 86a of the blower device 14a on the basis of the environmental parameters. The sensor unit 68a is configured to capture an air quality, an ambient pressure and/or an oxygen concentration.

The respiratory protection system 10a further comprises a vest 60a that is to be worn by a user 18a. The vest 60a is embodied as a textile vest. On a rear side of the vest 60a, the blower device 14a is arranged. The blower device 14a is releasably connected to the vest 60a. During operation, the blower device 14a is worn by a user 18a on his back via the vest 60a. The external operating unit 62a is moreover configured to be worn by a user on his chest. The external operating unit 62a is arranged on a front side of the vest 60a. Therefore, environmental parameters can be captured by means of the sensor unit 68a in particular in a head region of the user 18a.

The respiratory protection system 10a further comprises a breathing air line 46a, which is connected to the blower device 14a and is configured for guiding the breathing air flow 26a. The breathing air line 46a connects the blower device 14a to the mouth protection device 12a. The breathing air line 46a is connected to the blower device 14a via the air outlet opening 80a of the blower device 14a. The breathing air line 46a is embodied by a tube. In operation, the breathing air line 46a is configured for guiding the breathing air flow 26a.

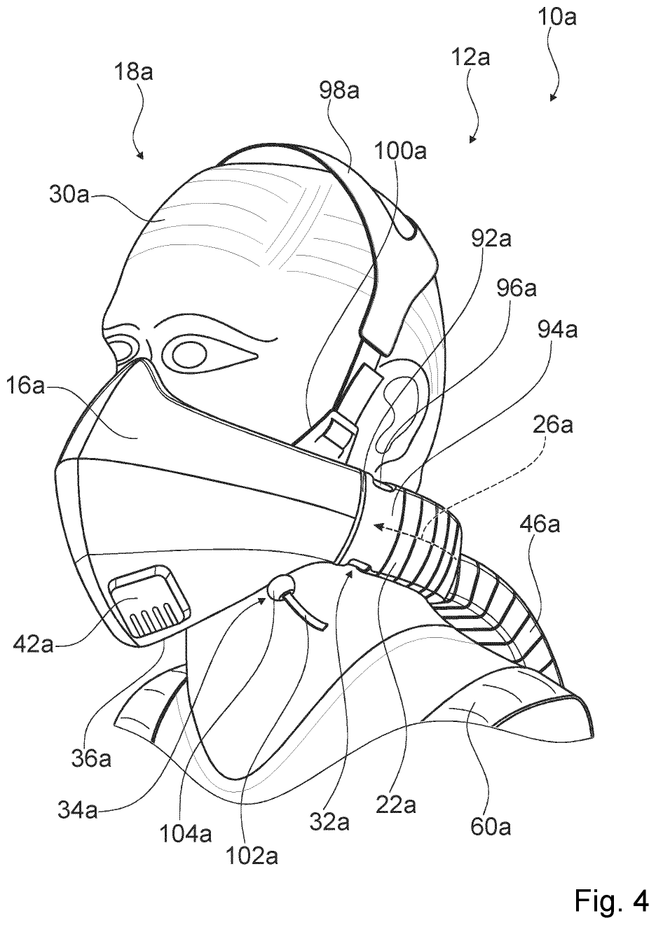

The mouth protection device 12a comprises a mask base body 16a. The mask base body 16a is configured to cover a mouth and nose region of the user 18a. Beyond this the mask base body 16a is configured to at least partially delimit a breathing zone 20a. In operation, the mask base body 16a, together with the face of the user 18a and a separating layer 38a, delimits the breathing zone 20a. The mask base body 16a is made at least largely of a flexurally soft material. The mask base body 16a is made completely of a flexurally soft material. The mask base body 16a is made completely of a dimensionally instable material. The mask base body 16a is made at least largely of a textile material. The mask base body 16a is completely made of a textile material. The mask base body 16a is made of a textile. The mask base body 16a is completely made of a textile. The mask base body 16a is implemented so as to be at least substantially airtight. It would in particular be conceivable that a textile which the mask base body 16a is made of has a coating which at least reduces air-permeability. The mask base body 16a is in particular airtight at least at an absolute pressure of 1 bar, preferably at least 2 bar and particularly preferentially at least 3 bar (FIG. 4).

The mouth protection device 12a further comprises a sealing element 90a. The sealing element 90a is fixedly connected to the mask base body 16a. The sealing element 90a is arranged at an upper edge of the mask base body 16a. The sealing element 90a is configured to seal the mask base body 16a, at least at an upper edge of the mask base body 16a, against the face of a user 18a. The sealing element 90a is configured to seal the breathing zone 20a and an outlet region 40a toward the eyes of the user 18a in order to avoid an airflow into the eyes of the user 18a. The sealing element 90a is made of a foam material. The sealing element 90a is realized by a foam material strip. By way of example, the sealing element 90a is glued with the mask base body 16a (FIG. 6).

The mouth protection device 12a further comprises a breathing air supply line 22a which is connected with the mask base body 16a. The breathing air supply line 22a delimits a breathing air channel 24a, which ends in the breathing zone 20a and is configured for guiding the active breathing air flow 26a. The breathing air supply line 22a is implemented by an elastic tube. By way of example, the breathing air supply line 22a has an oval cross section. However, a different cross section of the breathing air supply line 22a, deemed expedient by someone skilled in the art, would also be conceivable, like for example a circular cross section. The breathing air supply line 22a extends from the breathing air line 46a to the breathing air zone 20a.

Furthermore, the mouth protection device 12a comprises a further breathing air supply line 22′a, which is redundant to the breathing air supply line 22a and is connected to the mask base body 16a. The further breathing air supply line 22′a delimits a further breathing air channel, which ends in the breathing zone 20a and is configured for guiding an active breathing air flow 26a. The further breathing air supply line 22′a is implemented by an elastic tube. By way of example, the further breathing air supply line 22′a has an oval cross section. The further breathing air supply line 22′a extends from the breathing air line 46a to the breathing zone 20a. The further breathing air supply line 22′a is arranged on a side of the mask base body 16a that faces away from the breathing air supply line 22a. The breathing air supply lines 22a, 22′a are configured to be guided along on different sides of the head 30a of the user 18a. The further breathing air supply line 22′a has a function that is redundant to the breathing air supply line 22a. The further breathing air supply line 22′a serves for augmenting safety of a supply with the breathing air flow 26a. The breathing air supply line 22a and the further breathing air supply line 22′a are respectively functional independently from each other.

The breathing air line 46a that is connected with the blower device 14a is configured for guiding the breathing air flow 26a to the breathing air supply lines 22a, 22′a. The breathing air line 46a is furthermore configured to divide the breathing air flow 26a to the breathing air supply line 22a and the further breathing air supply line 22′a. The breathing air line 46a is coupled with the breathing air supply line 22a and the further breathing air supply line 22′a via a T-connection piece 108a. The T-connection piece 108a is configured to be arranged in a nape region of the user 18a.

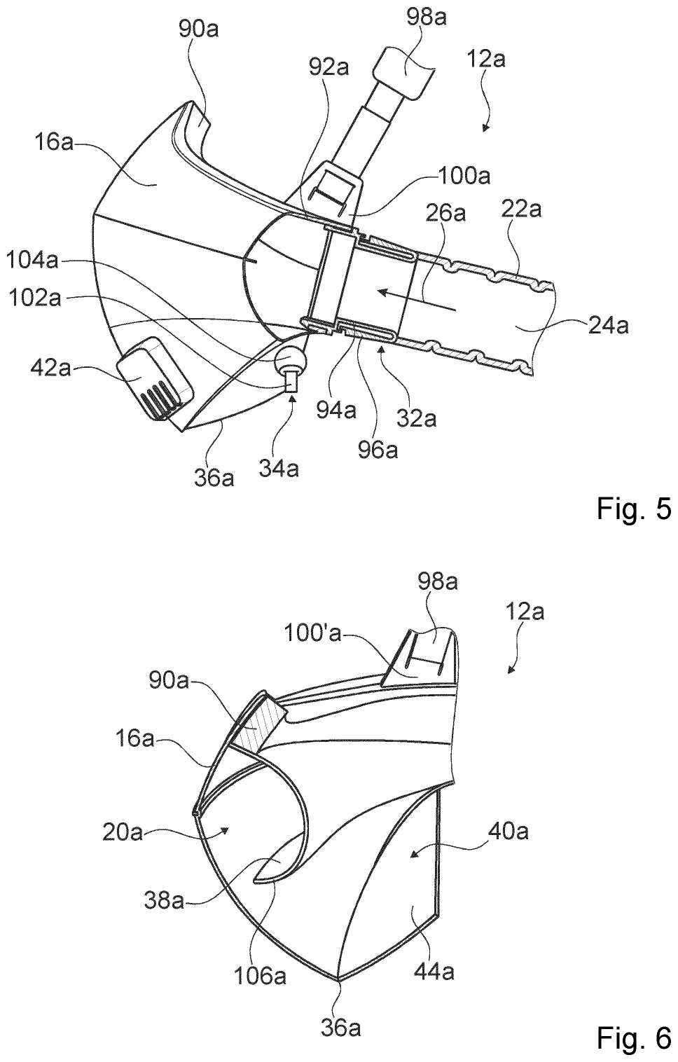

Beyond this the mouth protection device 12a further comprises a fastening strap 28a for fixing the mask base body 16a on the head 30a of the user 18a. The fastening strap 28a is embodied as an elastic strap, like in particular a rubber strap. The fastening strap 28a has a width corresponding at least approximately to a width of the breathing air supply line 22a. Furthermore, an effective length of the fastening strap 28a is realized so as to be adjustable. The fastening strap 28a extends from a first end of the mask base body 16a to an opposite-situated second end of the mask base body 16a. The fastening strap 28a extends from a first end of the mask base body 16a, in which the breathing air supply line 22a is connected with the mask base body 16a, to an opposite-situated second end of the mask base body 16a, in which the further breathing air supply line 22′a is connected with the mask base body 16a. In a state when the mouth protection device 12a is worn, the fastening strap 28a is configured to be guided around an occiput, in particular in a nape region. The mouth protection device 12a comprises at least one connection unit 32a for a simultaneous plug-in connection of the fastening strap 28a and the at least one breathing air supply line 22a, 22′a with the mask base body 16a. The mouth protection device 12a comprises the connection unit 32a and a further connection unit, which is not shown in detail, for a simultaneous plug-in connection of the fastening strap 28a with the breathing air supply line 22a and the further breathing air supply line 22′a, respectively, and with the mask base body 16a. The connection units 32a serve for pulling off or putting off the mouth protection device 12a. With the connection units 32a, a coupling is brought about for example via a plug-in movement. The connection units 32a in each case comprise a first coupling element 92a and a second coupling element 94a corresponding to the first coupling element 92a. The first coupling elements 92a of the connection units 32a exemplarily form in each case an interface receptacle, while the second coupling elements 94a of the connection units 32a in each case form an interface projection. The first coupling elements 92a of the connection units 32a are fixedly connected with the mask base body 16a at opposite ends respectively. The second coupling element 94a of the connection unit 32a is implemented fixedly with a first end of the fastening strap 28a and the breathing air supply line 22a. The further second coupling element of the further connection unit is implemented fixedly with a second end of the fastening strap 28a and the further breathing air supply line 22′a. The first coupling elements 92a of the connection units 32a are respectively implemented by a tube connection. The first coupling elements 92a of the connection units 32a are respectively configured to latch with the second coupling elements 94a of the connection units 32a. The second coupling elements 94a of the connection units 32a in each case comprise actuation elements 96a for releasing the latch connection (FIGS. 1, 5).

The mouth protection device 12a comprises a head-fastening strap 98a for an additional fixing of the mask base body 16a on the head 30a of the user 18a. Furthermore, an effective length of the head-fastening strap 98a is implemented so as to be adjustable. The head-fastening strap 98a extends from a first end of the mask base body 16a to an opposite-situated second end of the mask base body 16a. The head-fastening strap 98a extends from a first end of the mask base body 16a, in which the breathing air supply line 22a is connected with the mask base body 16a, to an opposite-situated second end of the mask base body 16a, in which the further breathing air supply line 22′a is connected with the mask base body 16a. In a state when the mouth protection device 12a is worn, the head-fastening strap 98a is configured to be guided around an occiput, particular an upper head. The mouth protection device 12a comprises a fastening unit 100a and a further fastening unit 100′a for an adjustable fastening of the head-fastening strap 98a with the mask base body 16a on said ends. For fastening, the head-fastening strap 98a is guided adjustably through recesses at the fastening units 100a, 100′a.

The mouth protection device 12a further comprises an adjusting unit 34a, by means of which at least an effective length of a side edge 36a of the mask base body 16a is implemented so as to be adjustable. By means of the adjusting unit 34a, an effective length of a side edge 36a is implemented so as to be adjustable from the first end of the mask base body 16a, in which the first coupling element 92a is arranged, to the second end of the mask base body 16a, in which the further first coupling element 92′a is arranged. The side edge 36a extends substantially parallel to a main extent direction of the mask base body 16a. The adjusting unit 34a comprises a cord 102a, in particular an elastic cord, and a cord clamp 104a. The cord 102a of the adjusting unit 34a extends in a channel of the mask base body 16a from the first end of the mask base body 16a to the second end of the mask base body 16a, which is situated opposite the first end. The cord 102a is fastened on the first end and on the second end. An effective length of the cord 102a, and thus also of the side edge 36a of the mask base body 16a, is implemented so as to be manually adjustable via the cord clamp 104a. In particular, an effective length of the cord 102a is implemented so as to be manually adjustable via the cord clamp 104a by the formation of different-sized loops of the cord 102a.

The mouth protection device 12a further comprises a separating layer 38a, which is connected with the mask base body 16a and is configured for an at least partial separation of the breathing zone 20a from an outlet region 40a. The outlet region 40a is at least partly delimited by the mask base body 16a. The outlet region 40a is arranged below the breathing zone 20a. In an operation state, the mask base body 16a delimits, together with the face of the user 18a, a spatial region that is divided into a breathing zone 20a and an outlet region 40a by means of the separating layer 38a. The separating layer 38a forms, together with the mask base body 16a, a channel which at least partly forms the breathing zone 20a and extends as far as a middle region of the mouth protection device 12a. The channel formed by the separating layer 38a extends from the breathing air channel 24a and the further breathing air channel as far as a user's mouth and/or nose region. In the user's mouth and/or nose region, the breathing zone 20a merges into the outlet region 40a. The separating layer 38a is implemented integrally with the mask base body 16a. The separating layer 38a protrudes perpendicularly to the mask base body 16a between the breathing zone 20a and the outlet region 40a. The separating layer 38a has in a middle region a recess 106a connecting the breathing zone 20a to the outlet region 40a. The separating layer 38a is implemented at least substantially of a textile material. The separating layer 38a is completely made of a textile. The separating layer 38a is configured for a defined air guidance. The separating layer 38a is configured to guide the breathing air flow 26a past the mouth and/or nose region of a user 18a before it reaches the outlet region 40a. For this purpose, the separating layer 38a has in its middle region the recess 106a, which connects the breathing zone 20a to the outlet region 40a. In operation, the breathing air flow 26a flows from the breathing air channel 24a and the further breathing air channel into the breathing zone 20a and from the breathing air zone 20a through the recess 106a into the outlet region 40a. The recess 106a is arranged in a proximity of the mouth and/or nose region of a user 18a (FIG. 6).

Beyond this the mouth protection device 12a comprises a discharge valve 42a, which is configured to regulate a pressure in the breathing zone 20a to an at least approximately constant value. The discharge valve 42a is implemented by an overpressure valve, in particular a one-way overpressure valve, which is configured to open if a defined overpressure is exceeded in the breathing zone 20a, respectively the outlet region 40a, relative to an environment. The discharge valve 42a is configured to permit, in particular maintain, a defined overpressure in the breathing zone 20a. Preferably the discharge valve 42a is implemented by a mechanical valve. The mask base body 16a is not completely sealed with respect to the face of the user 18a, such that air may also leave at a transition from the mask base body 16a to the face, besides the discharge valve 42a.

If at the transition from the mask base body 16a to the face there is too much leakage or if the mouth protection device 12a is taken off, it is no longer possible for the pressure in the breathing zone 20a to be maintained and the pressure drops below the limit value of the discharge valve 42a. This may be detected by the blower device 14a, in particular by a load of the fan 48a, and if applicable a warning signal may be given to the user 18a. In this way faulty wearing of the mouth protection device 12a can be indicated to the user 18a automatically. Furthermore, the fan 48a may thus stop automatically when the mouth protection device 12a is put on. Under regular conditions the pressure in the breathing zone 20a is regulated to an approximately constant value by means of the discharge valve 42a (FIG. 4).

It is also conceivable that the mask base body 16a comprises a subregion 44a which is implemented in an air-permeable fashion. The subregion 44a is in particular made of an air-permeable textile. The subregion 44a directly adjoins the outlet region 40a. The subregion 44a serves for a defined discharge of air in the outlet region 40a. The subregion 44a is provided in addition to the discharge valve 42a; it would however also be conceivable that only the subregion 44a is provided, the subregion 44a taking on the function of the discharge valve 42a.

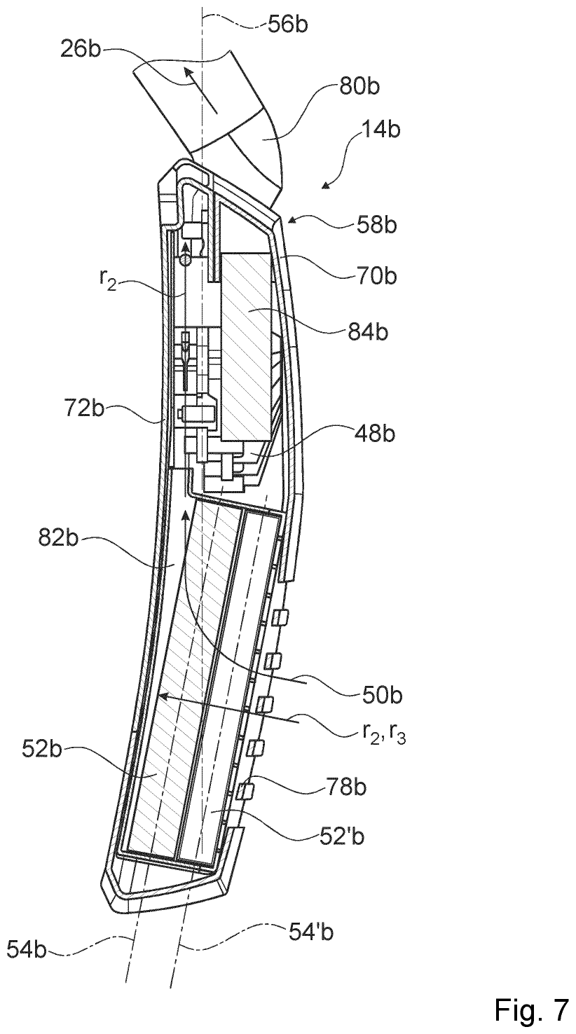

In FIG. 7 a further exemplary embodiment of the invention is shown. The following description is essentially limited to the differences between the exemplary embodiments, wherein regarding components, features and functions that remain the same, the description of the exemplary embodiment of FIGS. 1 to 6 may be referred to. In order to distinguish between the exemplary embodiments, the letter a that was added to the reference numerals of the exemplary embodiment of FIGS. 1 to 6 has been replaced by the letter b in the reference numerals of the exemplary embodiment of FIG. 7. Regarding components having the same denomination, in particular regarding components having the same reference numerals, the drawings and/or the description of the exemplary embodiment of FIGS. 1 to 6 may principally be referred to.

FIG. 7 shows a blower device 14b of a respiratory protection system. The blower device 14b is configured for a generation of a breathing air flow 26b. The blower device 14b is configured for a generation of a breathing air flow 26b for a mouth protection device.

The blower device 14b comprises a housing unit 58b. The housing unit 58b is implemented by a plastic housing. The housing unit 58b comprises two interconnected housing shells 70b, 72b, namely a first housing shell 70b and a second housing shell 72b. The housing unit 58b has a thickness d of less than 70 mm.

The blower device 14b further comprises a fan 48b for generating an airflow 50b. The blower device 14b is configured to create an overpressure in the mouth protection device 12b. The fan 48b is configured to create an overpressure in the mouth protection device 12b. The fan 48b is implemented by an electrical radial fan.

The blower device 14b further comprises a filter element 52b. The filter element 52b is configured to be flown through by the airflow 50b. The filter element 52b is implemented by a rectangular-cuboid-shaped filter module. The filter element 52b is implemented by an aerosol filter. The filter element 52b is embodied as a depth filter, in particular as a lamellate filter. A main extent plane 54b of the filter element 52b extends at least substantially parallel to a main extent plane of the housing unit 58b. The filter element 52b is arranged in a lower region of the blower device 14b. The housing unit 58b accommodates the fan 48b and the filter element 52b.

Furthermore the blower device 14b comprises a further filter element 52′b. The further filter element 52′b is configured to be flown through by the airflow 50b. The further filter element 52′b is configured to be flown through by the airflow 50b before the filter element 52b. The further filter element 52′b is implemented by a rectangular-cuboid-shaped filter module. The further filter element 52′b is implemented by an activated-carbon odor filter. A main extent plane 54′b of the further filter element 52′b extends at least substantially parallel to a main extent plane of the housing unit 58b. The further filter element 52′b is arranged in a lower region of the blower device 14b. The housing unit 58b accommodates the fan 48b, the filter element 52b and the further filter element 52′b. Air inlet openings 78b are arranged on an entry side of the further filter element 52′b. The further filter element 52′b is arranged on an entry side of the filter element 52b.

The fan 48b is arranged next to the filter element 52b, the airflow 50b being deflected between the fan 48b and the filter element 52b. The further filter element 52′b is also arranged next to the fan 48b. The filter element 52b, the further filter element 52′b and the fan 48b are together arranged in the housing unit 58b.

The housing unit 58b further comprises an air conveying channel 82b, which accommodates the filter element 52b and the further filter element 52′b and is configured for guiding the airflow 50b between the filter element 52b and the fan 48b.

The filter element 52b and the further filter element 52′b are arranged in a stacked fashion. The filter element 52b is arranged along the airflow 50b fluidically upstream of the fan 48b. The further filter element 52′b is arranged along the airflow 50b fluidically upstream of the filter element 52b. The airflow 50b between the fan 48b and the filter element 52b is deflected by at least approximately 90°. A deflection of the airflow 50b is brought about in the air conveying channel 82b. It would however also be conceivable that an air conveying channel 82b can be dispensed with. A flow-through direction r₁ of the airflow 50b through the filter element 52b is substantially different from a flow-through direction r₂ of the airflow 50b through the fan 48b. A flow-through direction r₃ of the airflow 50b through the further filter element 52′b is substantially different from the flow-through direction r₂ of the airflow 50b through the fan 48b. The flow-through direction r₃ of the airflow 50b through the further filter element 52′b corresponds essentially to the flow-through direction r₁ of the airflow 50b through the filter element 52b. The flow-through direction r₂ of the airflow 50b through the fan 48b runs parallel to a main extent plane 56b of the fan 48b. The flow-through direction r₁ of the airflow 50b through the filter element 52b runs perpendicularly to the main extent plane 54b of the filter element 52b. The flow-through direction r₃ of the airflow 50b through the further filter element 52′b runs perpendicularly to the main extent plane 54′b of the further filter element 52′b. The flow-through direction r₁ of the filter element 52b and the flow-through direction r₃ of the further filter element 52′b are angled by at least approximately 90° relative to the flow-through direction r₂ of the fan 48b.

### REFERENCE NUMERALS

10 respiratory protection system
12 mouth protection device
14 blower device
16 mask base body
18 user
20 breathing zone
22 breathing air supply line
22′ breathing air supply line
24 breathing air channel
24′ breathing air channel
26 breathing air flow
28 fastening strap
30 head
32 connection unit
32′ connection unit
34 adjusting unit
36 side edge
38 separating layer
40 outlet region
42 discharge valve
42′ discharge valve
44 subregion
46 breathing air line
48 fan
50 airflow
52 filter element
52′ filter element
54 main extent plane
54′ main extent plane
56 main extent plane
58 housing unit
60 vest
62 operating unit
64 operating element
66 control and/or regulation unit
68 sensor unit
70 housing shell
72 housing shell
74 cover
76 cover
78 air inlet opening
80 air outlet opening
82 air conveying channel
84 energy storage
86 control and/or regulation unit
88 cable
90 sealing element
92 coupling element
94 coupling element
96 actuation element
98 head-fastening strap
100 fastening unit
100 fastening unit
102 cord
104 cord clamp
106 recess
108 T-connection piece
d thickness
r₁ flow-through direction
r₂ flow-through direction
r₃ flow-through direction

1. A mouth protection device for a respiratory protection system, in particular a blower respiratory protection system, with at least one mask base body which is configured to cover a mouth and/or nose region of a user and which delimits a breathing zone at least partially, and with at least one breathing air supply line, which is connected to the mask base body and delimits at least one breathing air channel that ends in the breathing zone and is configured for guiding an active breathing air flow,
wherein the mask base body is made at least largely of a flexurally soft material, the mask base body being made at least largely of a textile material,
comprising
at least one adjusting unit, wherein at least an effective length of a side edge of the mask base body is implemented so as to be at least partially adjustable by means of the adjusting unit, wherein the effective length of the side edge is implemented so as to be adjustable by the adjusting unit from a first end of the mask base body, in which a first coupling element of the connection unit is arranged, to a second end of the mask base body, in which a further first coupling element of the connection unit is arranged, the side edge extending substantially parallel to a main extent direction of the mask base body, wherein the adjusting unit comprises a cord, in particular an elastic cord, and a cord clamp, the cord of the adjusting unit extending in a channel of the mask base body from the first end of the mask base body to the second end of the mask base body, which is situated opposite the first end, the cord being fastened on the first end and on the second end, wherein an effective length of the cord, and thus of the side edge of the mask base body, is implemented so as to be manually adjustable via the cord clamp.

2. The mouth protection device according to claim 1,
comprising
at least one further breathing air supply line, which is redundant to the breathing air supply line, which is connected with the mask base body and which delimits at least one further breathing air channel that ends in the breathing zone and is configured for guiding an active breathing air flow.

3. The mouth protection device according to claim 2,
wherein
the at least one further breathing air supply line is arranged on a side of the mask base body that faces away from the breathing air supply line.

4. The mouth protection device according to claim 1,
comprising
at least one fastening strap for fixing the mask base body on the head of a user, and the connection unit for a simultaneous plug-in connection of the fastening strap and the at least one breathing air supply line with the mask base body.

5. (canceled)

6. The mouth protection device according to claim 1,
comprising
at least one separating layer, which is connected to the mask base body and is configured to at least partially separate the breathing zone from an outlet region, the outlet region being at least partially delimited by the mask base body.

7. The mouth protection device according to claim 6,
wherein
the separating layer is at least substantially made of a textile material.

8. The mouth protection device according to claim 6,
wherein
the separating layer is configured for a defined air guidance, wherein the separating layer is configured to guide the breathing air flow past the mouth and/or nose region of a user before the breathing air flow reaches the outlet region.

9. The mouth protection device according to claim 1,
comprising
at least one discharge valve, which is configured to regulate a pressure in the breathing zone to an at least approximately constant value.

10. The mouth protection device according to claim 1,
wherein
the mask base body comprises at least one subregion which is implemented so as to be air-permeable.

11. A respiratory protection system, in particular a blower respiratory protection system, with a mouth protection device according to claim 1, and with at least one blower device for a generation of a breathing air flow.

12. The respiratory protection system according to claim 11,
wherein
the at least one blower device is configured to create an overpressure in the mouth protection device.

13. The respiratory protection system according to claim 11,
wherein
the at least one blower device is configured to create a volume flow of the breathing air flow of at least 50 l/min and maximally 250 l/min.

14. The respiratory protection system according to claim 11, comprising
at least one breathing air line, which is connected with the blower device, which is configured to guide the breathing air flow and is configured to divide the breathing air flow to the breathing air supply line and the further breathing air supply line.
